(19) United States
(12) Patent Application Publication
(10) Pub. No.: US 2025/0180432 A1
(43) Pub. Date: Jun. 5, 2025

(54) METHOD AND PRODUCTION SYSTEM

(71) Applicant: Klingelnberg AG, Zürich (CH)

(72) Inventor: Markus Finkeldey, Hattingen (DE)

(21) Appl. No.: 18/960,900

(22) Filed: Nov. 26, 2024

(30) Foreign Application Priority Data
Dec. 1, 2023 (EP) 23213679.6

(51) Int. Cl. G01M 13/021; B23F 1/06

(52) U.S. Cl. CPC G01M 13/021; B23F 1/06

(57) ABSTRACT

A method having the following steps: rolling test of toothed components; and gearing measurement of at least a subset of the toothed components; wherein a measurement requirement and a scope of the gearing measurement are determined on a component-specific basis as in dependence on a result of the rolling test.

### CROSS-REFERENCE TO RELATED APPLICATIONS

This application claims the benefit of European patent application 23213679.6, filed on 1 Dec. 2023, the disclosure of which is incorporated herein by reference in its entirety.

### TECHNICAL FIELD

The present disclosure relates to a method comprising the following method steps: Rolling test of toothed components and gearing measurement of at least a subset of the toothed components. The disclosure also relates to a production system.

### BACKGROUND

In modern motor vehicles that are partially or fully powered by an electric motor, the transmission noise is no longer masked by the noise of a combustion engine when driving with an electric motor. Transmission noise is therefore more clearly audible and can be perceived as disturbing by vehicle occupants.

It is known to subject all manufactured gears to a rolling test or noise test on a rolling test bench. If a gear is found to be noisy, the gear in question is measured on a coordinate or gear measuring machine. Furthermore, random samples of gears are measured on the gear measuring machine.

The time-limiting factor in the procedure outlined above is the measuring time of the gear measuring machine, which often operates in a purely tactile manner. The measurement of the relevant gear parameters, including the important waviness analysis with regard to noise behavior, requires up to 20 minutes using a tactile measuring system of a gear measuring machine, depending on the component geometry. It is clear that not all components can be measured in a tactile manner as part of series production due to this measuring time.

Hybrid gear measuring machines use both optical and tactile measuring devices for coordinate measurement. The use of optical measuring devices can reduce the measuring time compared to purely tactile measuring systems. However, a complete measurement of all relevant parameters still requires significantly more measuring time than the cycle of the gear cutting machine would dictate. The terms “measuring time” and “measuring duration” are used synonymously in this text.

Despite the aforementioned challenges with regard to measurement duration, there is a constant demand for further improved quality control with regard to the noise behavior of gearings. This can be achieved, for example, by increasing the scope of measurement, i.e. the number of parameters measured on a gearing, and also by increasing the sample size, i.e. the number of gearings measured, up to and including the measurement of all manufactured gearings.

If tactile gear measuring systems are used for gearing measurement, the above measures result in a further significant increase in measuring time. Even the use of a hybrid gear measuring machine does not achieve the goal for the example of measuring all manufactured gearings. The measuring time for the parameters “pitch”, “profile”, “flank” and “waviness”, including the recording of auxiliary variables such as the axis position or similar, and the loading of the hybrid gear measuring machine is approx. 2-3 minutes. However, the machine cycle sometimes specifies an available measuring time of less than 60 seconds. This means that although the hybrid measurement can significantly reduce the measuring time, it is still a long way from the machine cycle.

### SUMMARY

Against this background, the present disclosure is based on the technical problem of specifying a method for processing toothed components which enables improved noise control. Furthermore, a production system is to be specified.

The technical problem described above is solved in each case with the features of the independent claims. Further designs of the disclosure result from the dependent claims and the following description.

According to the disclosure, a method is provided comprising the following method steps: Rolling test of toothed components and gearing measurement of at least a subset of the toothed components. The method is characterized in that a measurement requirement and a scope of the gearing measurement are determined on a component-specific basis in dependence on a result of the rolling test.

This means that for a component in question, it is first determined, depending on the result of the rolling test of this component, whether this component is measured by means of a gearing measurement or not, i.e. the measurement requirement is determined. Determining the measurement requirement is therefore a yes/no decision, wherein the component is either transferred to the gearing measurement or is not transferred to the gearing measurement.

If there is a need for measurement, the determination of the scope of the gearing measurement relates in particular to the determination of the parameters to be measured on the component, such as the pitch, the concentricity or the like. This is because investigations by the applicant have shown that certain dynamic abnormalities or dynamic deviations of the gearing measured by means of the rolling test can be assigned to certain geometric deviations of the gearing. The term “scope” therefore does not denote a dimension in the sense of a geometric circumference of the component, but rather the specification or compilation of the test characteristics or parameters to be measured for a measurement on this component—i.e. the measurement task.

If the rolling test shows, for example, that the dynamic anomalies of the gearing are not the result of a waviness of the tooth flanks but of a pitch error, the time-consuming waviness measurement can be dispensed with for the component in question. In other words, the geometric parameters that are relevant for conspicuous dynamic deviations of the gearing can be identified on the basis of the result of the rolling test and the measurement task can be limited to these geometric parameters on a component-specific basis.

This reduces the overall measurement time, as only the component-specific measurement scope is carried out in the gearing measurement for each component for which a measurement is required.

It may therefore be provided that a complete set of measurement parameters is defined for the gearing of the components to be manufactured, which comprises the entirety of those parameters for the gearing measurement that cover all relevant geometric deviations for this gearing, such as the parameters: pitch, concentricity, wobble, flank shape, profile shape, angular deviations in profile and flank direction, tooth thickness deviation, surface waviness or topography deviations and the like.

It may also be provided that a measurement parameter set is selected on a component-specific basis, which is a selection or a subset of this complete measurement parameter set, wherein at least one parameter or several parameters of this complete measurement parameter set are not part of the measurement parameter set determined on a component-specific basis. In this way, each component can be measured as required with the shortest possible measurement duration, wherein only the component-specific required parameters are measured.

In other words, the measurement task for the gearing measurement can be optimized on a component-specific basis using the result of the rolling test for this component. In particular, the measurement task for the gearing measurement can be reduced on a component-specific basis based on the complete set of measurement parameters.

The term “complete set of measurement parameters” has only been introduced here for ease of understanding. For example, every gear measuring machine has a certain range of functions that can be used for every gearing to be measured. Even without the definition of a “complete set of measurement parameters”, it is therefore easily possible to adapt the scope of the measurement to the specific component by selecting from the available range of functions of the gear measuring machine on a component-specific basis. This also results in a component-specific scope of measurement in which, for example, a pitch measurement without waviness measurement is carried out for a first component on the basis of the rolling test, while the waviness measurement is carried out for a second component on the basis of the rolling test. A definition of a pool of certain parameters, which may be useful for the gearing measurement and from which a component-specific selection can then be made, may therefore have been carried out as a preparatory method step, but is in no way mandatory for the success or implementation of the method in question.

It may be provided that a rolling test is carried out for each component. In this case, the rolling test is referred to as a 100% test. This means that each component is subjected to a rolling test after hard finishing.

According to one design of the method, it is provided that a number of components for which the rolling test is carried out is greater than a number of components for which the gearing measurement is carried out. The gearing measurement is therefore not a 100% test. This means that not every component is subjected to the gearing measurement after its hard finishing.

It may be provided that for a component whose result of the rolling test meets the specified quality requirements of the rolling test, there is no measurement requirement and no gearing measurement is carried out, and that for a component whose result of the rolling test does not meet the specified quality requirements of the rolling test, there is a measurement requirement and a gearing measurement is carried out.

According to one design of the method, it is provided that deviations determined by means of the rolling test are provided as an order spectrum, wherein individual orders and/or order ranges of the order spectrum are assigned test features of the gearing, such as runout errors; wobble; pitch errors of the first order and/or higher orders; surface waviness, errors in the flank shape or the like.

The orders are defined in a known manner, in particular as a multiple of the rotational speed. Order analysis refers to the analysis of rotational frequencies and their multiples—with the order spectrum as the result of such an order analysis. In other words, it is in particular the transformation of a frequency analysis from a temporal plane into a rotational plane. The first order corresponds in particular to the rotational frequency during the rolling test, the second order to twice the rotational frequency of the rolling test, etc. Order spectra can, for example, relate to the speed or rotational frequency of the toothed component, the speed or rotational frequency of the master gear, the gear mesh frequency or similar. Order spectra can therefore be converted into each other without losing information.

It may be provided to use dominant orders of the order spectrum to determine the component-specific test characteristics or the parameters of the gearing to be measured that are measured in the gearing measurement.

According to one design of the method, it is provided that, in particular on the basis of dominant orders, a conclusion is drawn as to a need for correction for certain test characteristics or parameters to be measured, so that the presence of certain gearing errors can be concluded on the basis of the rolling test, in particular the presence of certain geometric gearing errors can be concluded.

It may be provided that for those test characteristics or parameters to be measured for which no dominant frequencies have been determined in the rolling test no gearing measurement is carried out.

The quality requirements of the rolling test can have absolute or relative limit values for amplitudes of one or more frequencies of the order spectrum.

It may be provided that a first range of the order spectrum is an indicator for a first gearing deviation and that a second range of the order spectrum is an indicator for a second gearing deviation which is different from the first gearing deviation, wherein orders associated with the first range are smaller than orders associated with the second range and wherein an abnormality of an order in the first range triggers a measurement requirement for the first gearing deviation and an abnormality of an order in the second range triggers a measurement requirement for the second gearing deviation.

According to one design of the method, it may be provided that a first range of the order spectrum is an indicator for pitch errors and that a second range of the order spectrum is an indicator for deviations of the waviness, wherein orders associated with the first range are smaller than orders associated with the second range and wherein an abnormality of an order in the first range triggers a measurement requirement for a pitch measurement and an abnormality of an order in the second range triggers a measurement requirement for a waviness.

It may be provided that a single order of the order spectrum is an indicator for a gearing deviation assigned to this single order and that a further single order of the order spectrum is an indicator for a second gearing deviation different from the first gearing deviation and assigned to this further single order, wherein the single order is different from the further single order and wherein an abnormality of the single order triggers a measurement requirement for the gearing deviation assigned to this order and an abnormality of the further single order triggers a measurement requirement for the further gearing deviation assigned to this further single order.

According to one design of the method, it is provided that corrections for the hard finishing process are determined on the basis of the results of the rolling test and/or the results of the gearing measurement. As is known, this can be a so-called method wherein correction values, e.g. for axis positions or feed rates for the hard finishing process, are determined on the basis of measured deviations of the gearing in order to compensate for the measured deviations.

It may be provided that an end-of-line test is carried out for a respective component after the gearing measurement by means of an end-of-line test bench, wherein the end-of-line test bench is in particular a gear test bench, or the end-of-line test of the gearing is carried out for a respective component after the rolling test and without a preceding gearing measurement by means of the end-of-line test bench. It may be provided that each gearing is fed to the end-of-line test bench and tested on the end-of-line test bench. In this way, the end-of-line test bench can be referred to as a 100% test.

The rolling test is not an end-of-line test, but a separate method step that is independent of the end-of-line test and is carried out on a separate rolling test bench that is independent of the end-of-line test bench.

The rolling test differs from the end-of-line test, for example, in that the gearing to be tested is not mounted in a gearbox housing during the rolling test. In contrast, the gearing to be tested is mounted in a gearbox housing during the end-of-line test in order to test the fully assembled state of the gearing to be tested, in particular with the corresponding mating gear, which will be installed together with the gearing to be tested in the fully assembled state. This results in a further difference between the end-of-line test and the rolling test, as a gearing to be tested rolls with a master gear during the rolling test and does not roll with the actual gearing installed in the fully assembled state.

It may be provided that the toothed components are hard-finished before the rolling test, wherein the hard finishing is carried out using a gear cutting machine.

Hard finishing can be a method for machining with a geometrically indeterminate cutting edge.

Hard finishing can be a grinding process. Hard finishing can be a single-division or continuous-division grinding process. The hard finishing process can be generating grinding or profile grinding. The grinding tool for grinding can be a grinding worm or a grinding wheel. The grinding tool for grinding processing can be a dressable grinding tool or a non-dressable grinding tool. Preferably, the hard finishing can be continuous generating grinding with a dressable grinding worm.

Hard finishing can be gear honing.

The hard finishing can be a gear lapping.

Hard finishing can comprise one or more processing steps selected from the steps “grinding”, “honing” or “lapping”.

The gear cutting machine can be a gear grinding machine. The gear grinding machine can have a dressing device with a dresser for dressing a dressable grinding tool.

The gear cutting machine can be a gear lapping machine.

The gear cutting machine can be a gear honing machine.

According to one design of the method, it is provided that the rolling test is carried out by means of the test bench for the rolling test.

The result of the rolling test can show a rotational error analysis.

The rolling test can be a single flank rolling test. The test bench for the rolling test can be a test bench for the single flank rolling test.

The single flank rolling test is characterized in that the gearing to be tested and a master gear of the test bench rolling with the gearing to be tested have a fixed center distance to each other. The master gear and the gearing to be tested are in single-flank contact with each other during the test. It may be provided that the gearing to be tested is driven in rotation by a motor. The master gear is braked accordingly, in particular by means of another motor, in order to set a test torque and a test speed or to set a test torque curve and a speed curve. A torsional acceleration sensor and an incremental angle measuring system can be arranged on a drive shaft of the gearing to be tested. Geometric deviations of the gearing to be tested generate measurable errors in the rotational transmission and the rotational acceleration. Vibration sensors can also be used.

The results of the single flank rolling test can be specified, for example: Runout, rolling deviation, runout error, tooth-to-tooth amplitude, maximum rolling deviation, transmission error and dynamic backlash, noise behavior, surface error.

The rolling test can be a double flank rolling test. The test bench for the rolling test can be a test bench for the double flank rolling test. The double flank rolling test is characterized in that the gearing to be tested and a master gear of the test bench rolling with the gearing to be tested have a variable center distance to each other. The master gear and the gearing to be tested are in two-flank contact with each other during the test. A force is applied, for example, to press the master gear mounted on an axially movable shaft with a defined force into a two-flank contact with the gearing to be tested. Geometric deviations of the gearing to be tested generate measurable axial displacements of the master gear shaft held on a test slide. Displacement transducers, rotary encoders, accelerometers and vibration sensors can be used for measurement.

The results of the double flank rolling test can be specified, for example: Center distance, runout, rolling jump, rolling deviation, two-ball dimension, noise behavior.

According to one design of the method, the gearing measurement is carried out by means of a coordinate measuring machine. The coordinate measuring machine can be a gear measuring machine.

The methods of rolling with rotational error analysis, or in particular single flank rolling testing and double flank rolling testing, are state of the art and are well known. The core of the disclosure is not the rolling test or the single flank rolling test or the double flank rolling test, but the use of the results of such a rolling test, in particular the single flank rolling test or the double flank rolling test, in order to determine the measurement requirement and the measurement range for a gearing measurement for a specific component. The disclosure therefore relates in particular to rolling test-controlled measurement, wherein the term “rolling test-controlled” relates to the recognition of the measurement requirement and the measurement range and the measurement process itself is not controlled by the rolling test. It is therefore also possible to refer to gearing measurement triggered by the rolling test, as the results of the rolling test trigger the component-specific measurement in the process chain or the measurement requirement and the measurement scope for the component-specific gearing measurement are determined based on the results of the rolling test.

The gear measuring machine can have a rotary table for holding and rotating a gearing to be measured around a rotation axis of the gearing.

The gear measuring machine can have a tactile measuring device. The tactile measuring device can have a measuring probe of a contact ball, which is set up to be brought into contact with a gear to be measured. The tactile measuring device can have several interchangeable measuring probes, wherein the respective measuring probes have different diameters of sensing spheres. The tactile measuring device can operate according to the measuring principle or the switching principle.

The gear measuring machine can have an optical measuring device. The optical measuring device can be an optical distance sensor, for example a confocal chromatic sensor, a laser distance measuring system or similar.

The disclosure also relates to a production system having a rolling test bench for rolling testing toothed components; having a gear measuring machine for measuring toothed components; having a control device, wherein the control device is set up to control the production system for carrying out a method according to the disclosure.

The production system can have a gear cutting machine for the hard finishing of toothed components.

### BRIEF DESCRIPTION OF THE DRAWINGS

The disclosure is explained in more detail below with reference to drawings illustrating exemplary embodiments, wherein the drawings schematically show in each case:

FIG. 1 shows a flow chart of a method according to the disclosure;

FIG. 2 shows a result of a rolling test;

FIG. 3 shows a gear measuring machine;

FIG. 4 shows a pitch measurement;

FIG. 5 shows a flank, profile and waviness measurement;

FIG. 6 shows a gear cutting machine for gear grinding;

FIG. 7 shows hard finishing as continuous generating grinding with a dressable grinding worm;

FIG. 7 shows a test bench for single flank rolling test;

FIG. 9 shows a test bench for two flank rolling test;

FIG. 10 shows an end-of-line test bench; and

FIG. 11 shows a production system according to the disclosure.

### DETAILED DESCRIPTION OF THE DRAWINGS

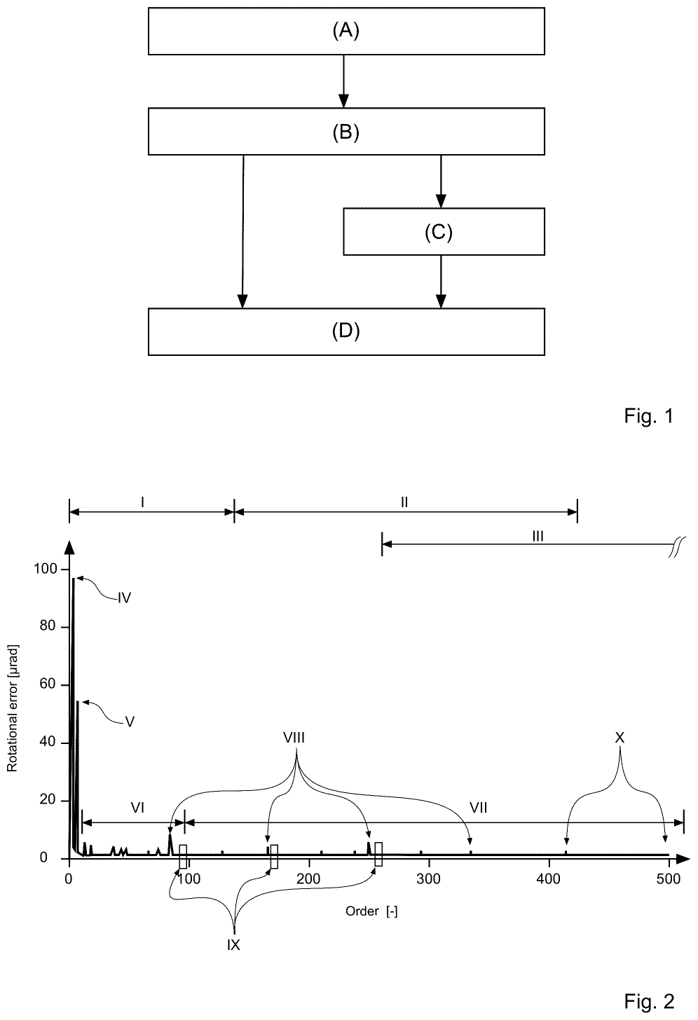

FIG. 1 shows a flow chart of a method according to the disclosure. The sequence according to FIG. 1 is repeated in series production according to the disclosure for each toothed component to be machined and is described below schematically and by way of example for a toothed component.

According to the disclosure, a hard finishing of a toothed component is first carried out in a method step (A).

The toothed component fed to method step (A) has been pre-geared and hardened before hard finishing.

The pre-gearing can, for example, be carried out by milling, in particular by hobbing. It is understood that, according to alternative exemplary embodiments, other processes can also be used for pre-gearing, in particular processes for cutting with a geometrically defined cutting edge, such as gear skiving or the like.

In a method step (B), the toothed component is subjected to a rolling test after hard finishing. Depending on the result of the rolling test, a measurement requirement and the scope of the gearing measurement for the toothed component are determined on a component-specific basis.

If the rolling test according to method step (B) has shown that there is a need for measurement, a gearing measurement is carried out for the toothed component in method step (C), corresponding to the circumference determined during the rolling test.

After the gearing measurement, the toothed component is subjected to an end-of-line test in accordance with method step (D).

If method step (B) has shown that no measurement is required, no gearing measurement is carried out for the toothed component, but the toothed component is fed directly to the end-of-line test according to method step (D) after the rolling test. The end-of-line test can be omitted according to alternative exemplary embodiments of the disclosure.

The flow chart in FIG. 1 shows that a rolling test is carried out for each toothed component. Furthermore, an end-of-line test is carried out for each toothed component. However, not every toothed component is fed to the gearing measurement.

As already mentioned in the introduction to this text, gearing measurement is the most time-consuming method step of the method steps described. For this reason, the results of the rolling test are first used to decide whether the toothed component must be subjected to a gearing measurement at all, and if so, to what extent this gearing measurement must be carried out, i.e. which test characteristics or which parameters to be measured must actually be recorded on the toothed component by means of the gearing measurement.

In series production, which provides a sequence according to FIG. 1 for each toothed component, it is therefore particularly provided that the number of toothed components for which the rolling test is carried out is greater than the number of toothed components for which the gearing measurement is carried out.

FIG. 2 shows a schematic example of the result of the rolling test according to method step (B). A measured rotational error is plotted in μrad over the orders. The orders are defined in a known manner as a multiple of the rotational speed. Order analysis refers to the analysis of rotational frequencies and their multiples. In other words, it is in particular the transformation of the frequency analysis from a temporal plane to a rotational plane. The first order corresponds to the rotational frequency during the rolling test, the second order to twice the rotational frequency of the rolling test, etc. The deviations determined by means of the rolling test are thus provided as an order spectrum with orders that correspond to a multiple of the rotational frequency during the rolling test. Individual orders or order ranges of the order spectrum can be assigned test characteristics or geometric deviations of the gearing of the toothed component.

Anomalies in the rolling test that occur in an order range I are due, for example, to pitch errors in the gearing of the toothed component. The order range I extends, for example, from the first order to approx. 160th order.

Anomalies in the rolling test that occur in an order range II are due, for example, to deviations in a profile or a flank of the gearing of the toothed component. The order range II extends, for example, from the 160th order to the 430th order.

Anomalies in the rolling test that occur in an order range III are due, for example, to waviness in the tooth flanks of the gearing of the toothed component. The order range III extends, for example, from the 290th order to beyond the 500th order.

The values given for the extent of the order ranges are to be understood merely as examples in order to illustrate the procedure according to the disclosure.

In order to provide an initial example of the evaluation of a component-specific order spectrum, the assumption is made that anomalies or dominant orders for a first component occur exclusively in order range I, while the amplitudes of the orders in ranges II and III are completely inconspicuous for this first component. From this it can be deduced that for this first component, for example, no time-consuming measurement of the waviness of the tooth flanks is required, as the dominant orders determined during the rolling test clearly indicate pitch errors and there are no problems with deviations in the waviness range.

There is therefore a need for measurement for this first toothed component, as dominant orders were detected in order range I, which indicate a pitch error. The relevant gearing of the first component must therefore be measured in accordance with the method in step (C). However, the scope of measurement for this first component in question can be limited to a pitch measurement, for example, as no anomalies are to be expected based on the results of the rolling test, for example with regard to the waviness of the tooth flanks.

For a second example, which concerns the analysis of an order spectrum of a second toothed component, however, the case may arise that dominant orders occur both in order range I and in order range III, which indicate deviations with regard to the pitch and also imply critical values on the surfaces of the tooth flanks. For this second component, too, it can therefore be determined on the basis of the order analysis that there is a need for measurement, i.e. a gearing measurement must be carried out for this second toothed component. In this case, the scope of measurement is extended compared to the first component described above, as the waviness of the tooth flanks must also be measured for the second component in addition to the pitch measurement.

If a need for measurement has been identified, the scope of the measurement can therefore be defined on a component-specific basis by using the analysis of the order spectrum to determine which geometric deviations of the gearing of the component in question cause the dominant orders in question according to the analysis of the order spectrum.

In addition to the aforementioned order ranges I, II and III, individual orders can also be assigned to specific test characteristics or specific geometric deviations of the relevant gearing.

For example, the first order of the order spectrum according to the rolling test describes the runout error of a gear, wherein the associated rotational error of the first order is designated here as IV. The second order of the order spectrum according to the rolling test corresponds to the wobble of the gearing, wherein the associated rotational error of the second order has been designated here as V.

An order range, which has been designated VI, extends from the third order of the rolling test to the first tooth meshing order, wherein dominant orders within this order range indicate periodically occurring pitch errors.

An order range, which is designated as VII, is assigned to those orders of the rolling test that cannot be assigned to meshing frequencies or their harmonic or harmonic sidewalls, wherein these orders can also be referred to collectively as ghost orders.

The individual tooth meshing orders according to the first, second, third and fourth meshing orders are labeled VIII.

IX refers to the ranges that affect the sidebands of the harmonic meshing frequencies that are modulated by periodic pitch deviation.

Tooth meshing orders according to the fifth tooth meshing order or higher are labeled X and are usually due to waviness of the surface of the flanks.

It is therefore evident that some information on the geometric deviations of the gearing of a toothed component in question can already be derived from an analysis of an order spectrum of the rolling test. According to the disclosure, a rolling test-controlled measurement requirement is now determined on the basis of this information, i.e. the time-consuming measurement of the gearing geometry is limited to the measurements that are actually necessary.

Furthermore, this also means that no gearing measurement is carried out if no anomalies that would make a gearing measurement necessary are found for a relevant gearing of a toothed component during the rolling test.

The analysis of the order spectrum of the rolling test can be based on predefined quality requirements or quality characteristics. For example, absolute or relative limit values for the amplitudes of the rotational error can be specified for the order ranges and or for individual orders, wherein exceeding a relevant limit value triggers a measurement requirement for the correspondingly assigned test characteristic.

Specifically, for example, it may be provided that the first-order rotational error in the rolling test may be a maximum of 20 μrad or a maximum of 40 μrad or a maximum of 60 μrad. If this value is exceeded, as is the case in the example shown in FIG. 2, there is a need to measure the pitch and concentricity.

For the second-order rotational error, i.e. the wobble, such a limit value for the permissible rotational error can be lower. For example, it may be provided that the second-order rotational error may be a maximum of 10 μrad or 20 μrad, so that there is a measurement requirement for the example shown in FIG. 2, as the second-order rotational error here is approx. 55 μrad.

Thus, limit values for the permissible rotational error can be specified for the various order ranges or for the various individual orders, the exceeding of which triggers a measurement requirement for one or more test characteristics of the gearing assigned to the respective order range or the respective order.

Such limit values can also be defined relatively, wherein, for example, a ratio of the rotational errors of different orders can be formed, or the rotational error can be standardized for certain orders and compared with a limit value defined with respect to the standardized rotational error.

Orders for which a specified limit value is exceeded can also be referred to as dominant orders of the order spectrum. Alternatively, it can also be said that certain orders or order ranges exhibit anomalies or are conspicuous if the analysis of the order spectrum of the rolling test shows that a specified limit value has been exceeded.

Corrections for hard finishing can be determined based on the results of the rolling test and/or the results of the gearing measurement. These corrections can, for example, include corrected axis movements or correction values for axis movements for hard finishing, or corrections for certain production parameters such as an infeed depth, a feed rate or similar.

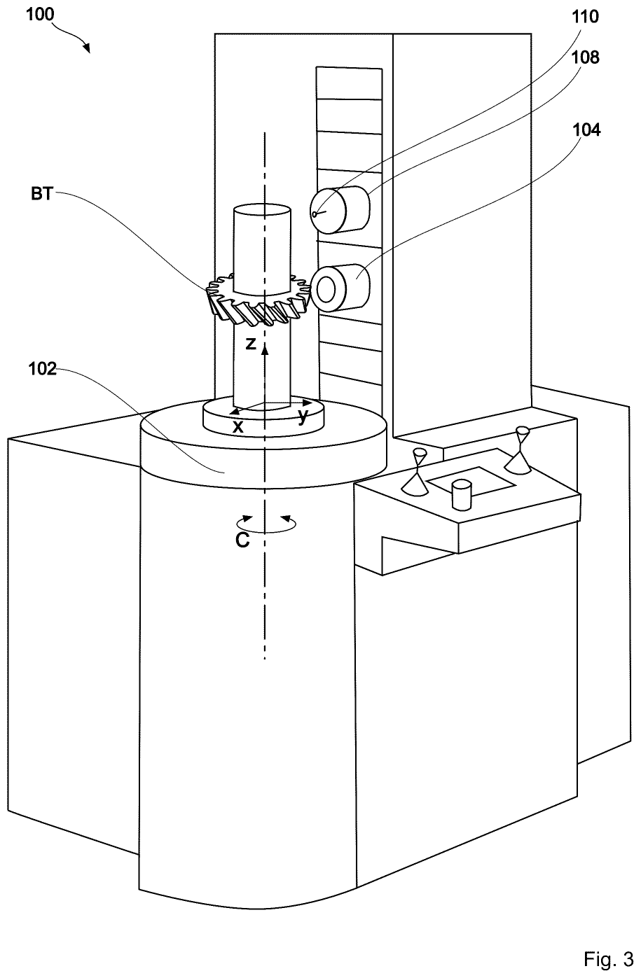

FIG. 3 shows a gear measuring machine 100 for measuring gearings. A component BT is shown below partly as helical gearing and partly as spur gearing. The component BT is merely a placeholder for a toothed component of any kind. It is understood that the method according to the disclosure can be used regardless of the tooth shape or the specific design of the toothed component.

The gear measuring machine 100 is a coordinate measuring machine which has a rotary table 102 for holding and rotating the component BT about an axis of rotation C. The gear measuring machine 100 has an optical measuring device 104 for optical gearing measurement and a tactile measuring device 108 with a measuring probe 110 for tactile gearing measurement. The gear measuring machine 100 can therefore be described as a hybrid coordinate measuring machine, since it enables both tactile measurement and optical measurement.

If a measurement requirement has been determined according to a rolling test, the corresponding gearing measurement takes place on a gear measuring machine 100 shown as an example in FIG. 3.

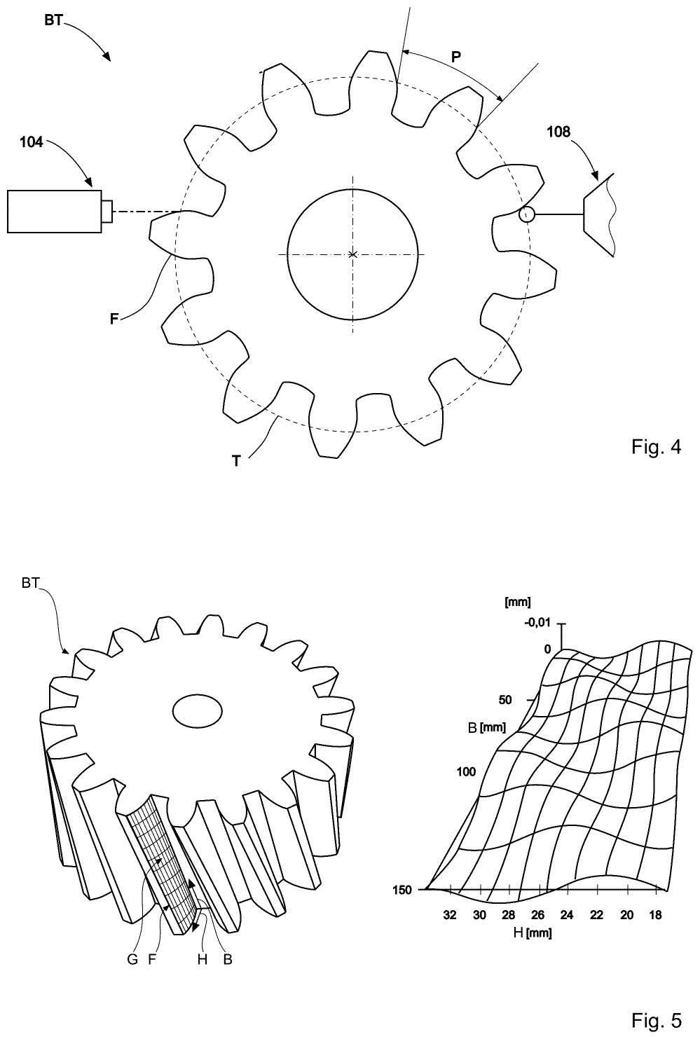

FIG. 4 shows a schematic example of the measurement of a pitch P on the toothed component BT. Here, flanks F of the component BT are measured by means of the optical measuring device 104 or by means of the tactile measuring device 108. The pitch P is measured in particular at the level of the pitch circle T of the toothed component BT.

FIG. 5 shows a schematic example of a component BT designed as helical gearing. To detect a waviness, a measuring grid G is defined along a width B and a height H to detect the entire tooth flank F. The measuring grid G defined in this way is scanned by means of tactile measurement or optical measurement in order to detect measuring points corresponding to the measuring grid on the tooth flank. The result of such a measurement of the waviness is shown as an example and schematically in FIG. 5 on the right-hand side, wherein deviations are plotted over the height and width of the tooth flank in question.

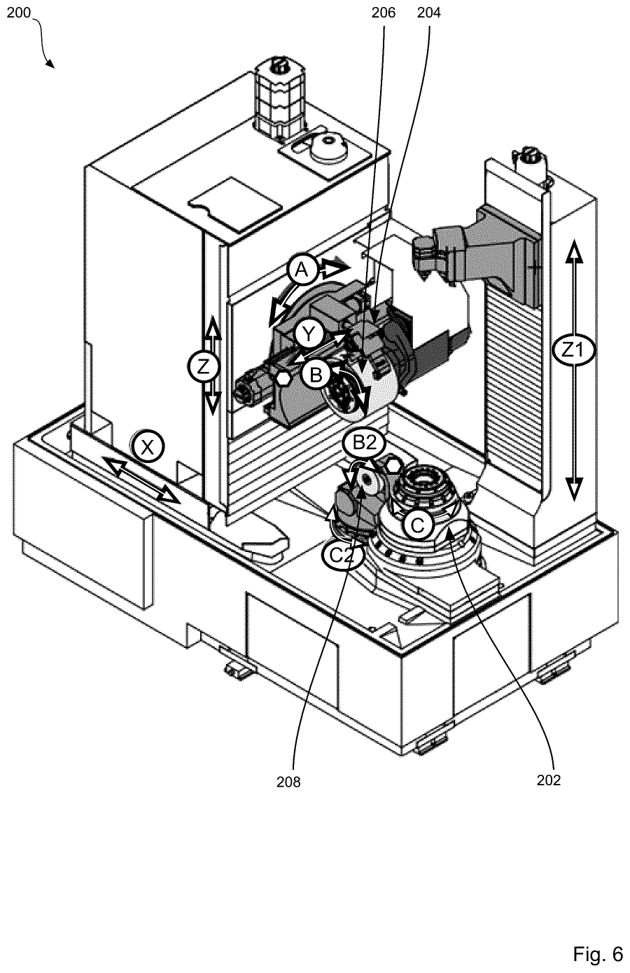

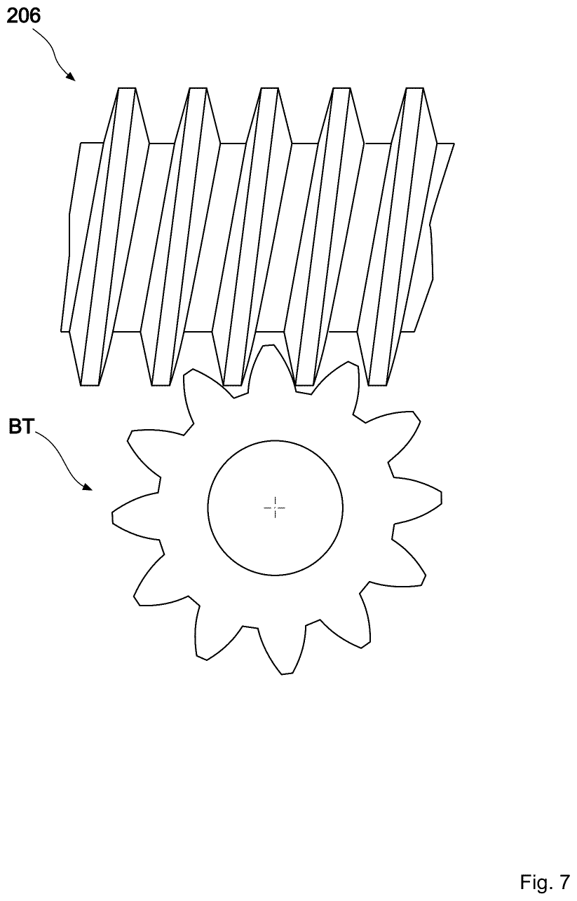

FIG. 6 shows a schematic example of a gear cutting machine 200 for gear grinding. The gear cutting machine 200 has a workpiece spindle for holding a workpiece BT to be machined and a tool spindle 204 for holding a grinding tool, wherein the grinding tool 206 is designed in the present case as a dressable grinding worm. As is known, the gear cutting machine 200 has controlled machine axes in order to execute relative movements for the grinding machining of the toothed component BT. The corresponding degrees of freedom of movement or the machine axes are designated X, Y, Z, A, B and C in the present case, wherein the axes C2 and B2 are assigned to a dressing device 208 for dressing the grinding tool 206. The axis Z1 is used for clamping shaft-shaped components.

FIG. 7 shows a schematic example of the dressable grinding worm 206 during grinding of the toothed component BT.

FIG. 8 shows a schematic example of a test bench 300 for single flank gear rolling testing. The test bench 300 has a master gear 302 that is in meshing engagement with the toothed component BT to be tested for rolling. A center distance a1 between a shaft 303, which carries the master gear 302, and a shaft 308, which carries the toothed component BT, is constant in the present case. Furthermore, devices or gear testing machines are known which are suitable for both single flank gear testing and double flank gear testing, such as the gear testing machine of the applicant marketed under the name R300. Such machines are suitable, for example, for single flank rolling tests, structure-borne sound and torsional acceleration tests and double flank rolling tests.

A torque and a speed for testing the toothed component BT are set via the drives 310 and 306. Measured values are recorded by means of sensors 304, 312, 314 and 316, which can be angle sensors, rotational acceleration sensors and vibration or noise sensors.

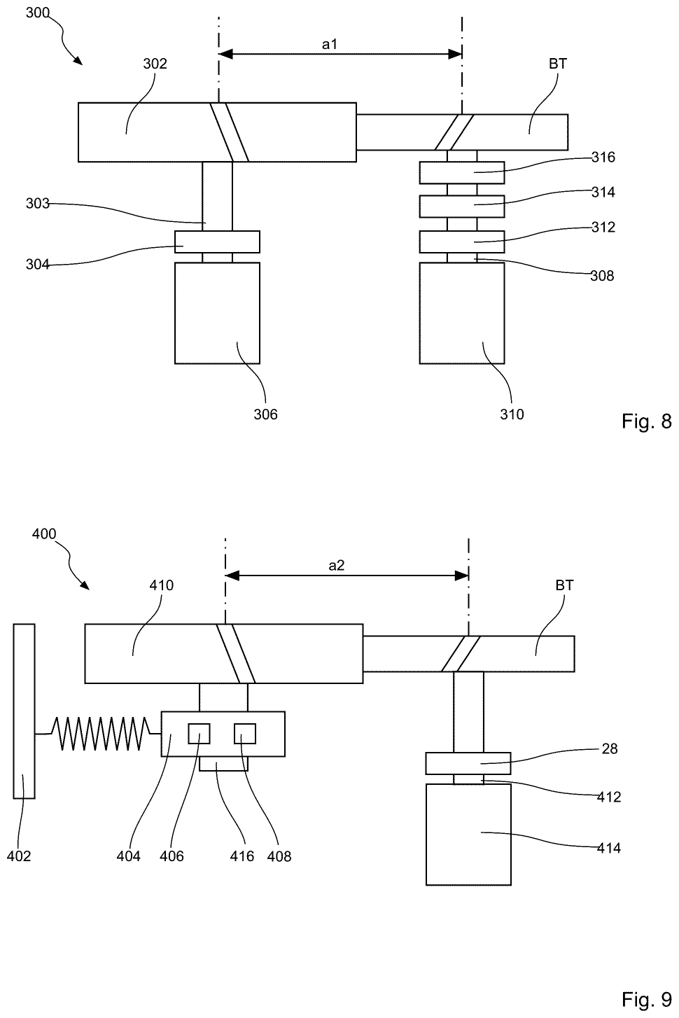

FIG. 9 shows a schematic example of a test bench 400 for double flank rolling testing. A master gear 410 is accommodated on a shaft 416, wherein the shaft 416 is held on a loadable carriage 404, which is displaceable relative to a support structure 402. The master gear is resiliently elastically pretensioned in the direction of the toothed component BT in order to produce a defined contact in the two-flank contact between the master gear 410 and the toothed component BT. A center distance a2 between the shaft 416 and a shaft 412, on which the toothed component BT is held, is variable in the present case. The shaft 412 is assigned a drive 414 for driving the shaft 412 in rotation. Furthermore, sensors 406, 408 are provided for measuring the changes in the center distance a2. The reference sign 28 represents a further sensor 28, which can perform an angle measurement and/or a rotational acceleration measurement and/or a vibration measurement.

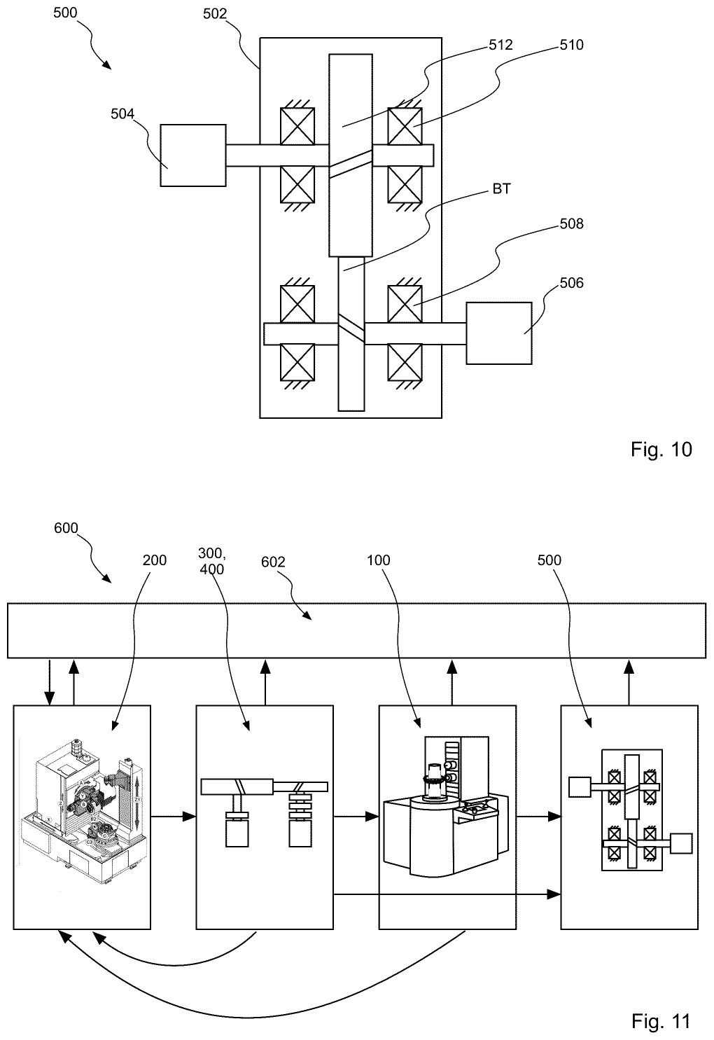

FIG. 10 shows a schematic example of an end-of-line test bench 500, wherein the toothed component BT is mounted in a gearbox housing 502, wherein a bearing 508, 510 corresponding to the installation state is provided both for the toothed component BT and for a corresponding mating gear 512. Drives 504 and 506 are provided to set the desired speeds and torques for testing the toothed component BT. It may be provided that the gearbox housing and the toothed component 512 or the mating gear 512 are part of the gear actually delivered. Alternatively, the housing 512 may merely be a housing that is structurally identical to the housing in which the relevant toothed component BT is accommodated in the fully assembled state. This applies equally to the associated mating gear 512. The end-of-line test bench 500 can also be referred to as a gear test bench.

FIG. 11 shows a schematic example of a production system 600, having the gear cutting machine 200 for hard finishing of toothed components BT, having a rolling test bench 300 or 400 for rolling testing of toothed components BT, a gear measuring machine 100 for measuring toothed components BT and an end-of-line test bench 500. The production system 600 also has a control device 602, wherein the control device is set up to control the production system 600 for carrying out the method according to the disclosure described above.

Accordingly, the control device 602 is used to automatically determine whether a measurement requirement exists after the rolling test of the toothed component, so that the toothed component BT, if a measurement requirement exists, is fed to the gear measuring machine 100 and is measured there to a component-specific defined extent, or, if no measurement requirement exists, can be fed directly to the end-of-line test bench 500 after the rolling test.

The results of the gearing measurement using the gear measuring machine 100 can be used to derive corrections for the gear grinding machine 200. Similarly, corrections for the gear grinding machine can be determined based on the results of the rolling test.

1. A method including the following steps:
rolling test of toothed components; and
gearing measurement of at least a subset of the toothed components;
wherein a measurement requirement and a scope of the gearing measurement are determined on a component-specific basis in dependence on a result of the rolling test.

2. The method according to claim 1,
wherein a rolling test is carried out for each toothed component.

3. The method according to claim 1,
wherein a number of the toothed components for which the rolling test is carried out is larger than a number of the toothed components for which the gearing measurement is carried out.

4. The method according to claim 1,
wherein for a toothed component whose result of the rolling test meets specified quality requirements of the rolling test, there is no need for measurement and no gearing measurement is carried out, and
wherein for a toothed component whose result of the rolling test does not meet the specified quality requirements of the rolling test, there is a need for measurement and a gearing measurement is carried out.

5. The method according to claim 1,
wherein deviations determined using the rolling test are provided as an order spectrum, wherein individual orders and/or order ranges of the order spectrum are assigned test features of the gearing, such as runout errors; wobble: pitch errors of the first order and/or higher orders; surface waviness, and errors of the flank shape.

6. The method according to claim 5,
wherein those test characteristics of the gearing which are measured in the gearing measurement are determined component-specifically on the basis of dominant orders of the order spectrum.

7. The method according to claim 6,
wherein for those test characteristics for which no dominant orders have been determined in the rolling test no gearing measurement is carried out.

8. The method according to claim 7, wherein
the quality requirements of the rolling test have absolute or relative limit values for amplitudes of one or more orders of the order spectrum.

9. The method according to claim 5, wherein a first range of the order spectrum is an indicator for a first gearing deviation and in that a second range of the order spectrum is an indicator for a second gearing deviation which is different from the first gearing deviation, wherein orders associated with the first range are smaller than orders associated with the second range and wherein an abnormality of an order in the first range triggers a measurement requirement for the first gearing deviation and an abnormality of an order in the second range triggers a measurement requirement for the second gearing deviation,
a first range of the order spectrum is an indicator for pitch errors and in that a second range of the order spectrum is an indicator of deviations of the waviness, wherein orders associated with the first range are smaller than orders associated with the second range and wherein an abnormality of an order in the first range triggers a measurement requirement for a pitch measurement and an abnormality of an order in the second range triggers a measurement requirement for a waviness;
and/or
wherein a single order of the order spectrum is an indicator for a gearing deviation assigned to this single order and in that a further single order of the order spectrum is an indicator for a second gearing deviation different from the first gearing deviation and assigned to this further single order, wherein the single order is different from the further single order and wherein an abnormality of the single order triggers a measurement requirement for the gearing deviation assigned to this order and an abnormality of the further single order triggers a measurement requirement for the further gearing deviation assigned to this further single order.

10. The method according to claim 1,
wherein corrections for the hard finishing process are determined on the basis of the results of the rolling test and/or the results of the gearing measurement.

11. The method according to claim 1,
wherein an end-of-line test is carried out for a respective toothed component after the gearing measurement using an end-of-line test bench, wherein the end-of-line test bench is a gear test bench, or the end-of-line test of the gearing is carried out for a respective toothed component after the rolling test and without preceding gearing measurement using the end-of-line test bench.

12. The method according to claim 1, wherein
the rolling test is performed using the rolling test bench; and
the gearing is measured using a coordinate measuring machine.

13. The method according to claim 1,
wherein the toothed components are hard-finished before the rolling test, wherein the hard finishing is carried out using a gear cutting machine.

14. A production system,
having a rolling test bench for testing toothed components;
having a gear measuring machine for measuring toothed components;
having a control device, wherein the control device is set up to control the production system for carrying out a method according to claim 1.

15. The production system according to claim 14,
wherein a gear cutting machine for the hard finishing of toothed components.
